(19) United States
(12) Patent Application Publication
(10) Pub. No.: US 2011/0248946 A1
(43) Pub. Date: Oct. 13, 2011

(54) MULTI-MODE PROSTHETIC DEVICE TO FACILITATE MULTI-STATE TOUCH SCREEN DETECTION

(75) Inventors: Paul Roller Michaelis, Louisville, CO (US); David Scott Mohler, Arvada, CO (US); Richard L. Robinson, Broomfiled, CO (US)

(73) Assignee: AVAYA INC, Basking Ridge, NJ (US)

(21) Appl. No.: 12/756,375

(22) Filed: Apr. 8, 2010

(51) Int. Cl. G06F 3/041; G06F 3/045

(52) U.S. Cl. 345/174; 345/173

(57) ABSTRACT

Aspects are directed toward an active prosthetic that includes, for example, an LED, RF transponder, or comparable electrical, optical, and/or electromagnetic componentry that allows the characteristics of the prosthetic to be changed. These characteristics then can be correlated to different modes of operation when used with a corresponding input device. Other aspects are directed toward utilizing prosthetics with different shapes to affect different modes of behavior and input with an input device, such as a touchscreen or touchpad. Even further aspects are directed toward providing handicapped individuals with increased dexterity by providing a prosthetic that allows different modes of behavior when used with an associated input device.

### RELATED APPLICATION DATA

This application is related to:

U.S. application Ser. No. 12/689,493, filed Jan. 19, 2010, entitled “Detection of a Rolling Motion or Sliding Motion of a Body Part on a Surface,”

U.S. application Ser. No. 12/689,567, filed Jan. 19, 2010, entitled “Event Generation Based on Print Portion Identification,”

U.S. application Ser. No. ______ (Atty. Docket No.: 4366YDT-60), filed herewith, entitled “Multi-Mode Touchscreen User Interface For A Multi-State Touchscreen Device,” all of which are incorporated herein by reference in their entirety.

### FIELD

One exemplary aspect is directed toward input devices. Even more particularly, an exemplary aspect is directed toward a prosthetic user interface with multiple modes.

### BACKGROUND

A touchpad, which is also known as a track pad, is an input device that includes a special surface that is capable of translating the motion and position of a user's finger to a relative position on, for example, a screen. Touchpads are becoming even more abundant on laptop computers, and also can be used as a substitute for a computer mouse when, for example, there is limited space. Touchpads vary in size but are rarely made larger than 40 square cm with their size generally being proportional to the device which with they are associated. They can also be found on personal digital assistants (PDAs), portable media players, laptops, netbooks, and the like.

In general, touchpads operate either based on capacitive sensing and/or conductance sensing. The most common technology used entails sensing the capacitance of a finger, or the capacitance between sensors. Because of the property being sensed, capacitance-based touchpads will not sense the tip of a pencil or other similar implement. Gloved fingers will generally also be problematic, and may cause problems when a user is trying to operate the device.

Touchpads, similar to touchscreens, by their design, are able to sense absolute positions, with precision being limited by their size. For common use as a pointing device, the dragging motion of a finger is translated into a finer, relative motion of the cursor on the screen, and analogous to the handling of a mouse that is lifted and put back on a surface. Buttons comparable to those present on a mouse are typically below, above, or beside the touchpad with a button serving in a similar manner to that as the buttons on a mouse. Depending on the model of the touchpad and drivers behind it, you may also be able to click by tapping your finger on the touchpad and a drag with tap followed by a continuous pointing motion (a click and a half). Touchpad drivers can also allow the use of multiple fingers to facilitate functionality corresponding to the other mouse buttons, commonly a two-finger tapping is correlatable to the center button of a mouse.

Some touchpads also have “hot spots” which are locations on the touchpad that indicate user intentions other than pointing. For example, on certain touchpads, moving the finger along an edge of the touchpad will act as a scroll wheel, controlling the scroll bar and scrolling the window that has the focus vertically or horizontally depending on which edge is stroked. Some companies use two-finger dragging gestures for scrolling on their track pads, with these typically being driver dependent functions that can be enabled or disabled by a user. Some touchpads also include tap zones which are regions whereby a tap will execute a predetermined function. For example, the function could be pausing of the media player or launching of an application.

There are two principal technologies that are used in touchpads. In a matrix approach, a series of conductors are arranged in an array of parallel lines into layers, separated by an insulator and crossing each other at right angles to form a grid. A high frequency signal is applied sequentially between pairs in this two-dimensional grid array. The current that passes between the nodes is proportional to the capacitance. When a virtual ground, such as a finger, is placed over one of the intersections between the conductive layer, some of the electric field is shunted to this virtual ground point, resulting in a change in the apparent capacitance at this location.

In the capacitive shunt method, the pad senses the changing capacitance between a transmitter and a receiver that are on opposite sides of the sensor. The transmitter creates an electric field which osculates typically between 200 and 300 khz If a ground point, such as finger, is placed between the transmitter and receiver, some of the filed lines are shunted away, thereby decreasing the apparent capacitance. These changes in capacitance are then used as input from the device.

There are also touchpads that have advanced functionality, such as letting users scroll in an arbitrary direction by touching the pad with two fingers instead of one, and then moving their fingers across the pad in the direction they wish to scroll. Other enhanced functionality includes the ability to allow users to do various combinations of gestures, such as swiping four fingers up or down to activate a particular application.

A touchscreen is an electronic visual display that can detect the presence and location of a touch within the display area. The term generally refers to touch or contact to the display of the device by a finger, fingers, or a hand. Touchscreens can also sense other passive objects, such as a pen. In general, any screen that allows a user to interact physically with what is shown on the display, via direct manipulation, is typically categorized as a touchscreen.

Touchscreens typically have two main attributes. The first is that the touchscreen enables one to interact with what is displayed directly on the screen, where it is displayed, rather than indirectly with a mouse or a touchpad. Secondly, a touchscreen allows a user to interact with the display without requiring any intermediate device, again, such as a stylist, mouse, or the like, that would usually be held in the hand. These devices are often seen in tablet PCs, and are also prominent in many digital appliances such as PDAs, satellite navigation devices, mobile phones, mobile entertainment devices, video games, and the like.

There are a number of technologies that support various touchscreens, such as resistive technologies, surface acoustic wave technologies, capacitive technologies, surface capacitance technologies, projected capacitance technologies, strain gauge technologies, optical imaging technologies, dispersive signal technologies, acoustic pulse recognition technologies, and coded LCD (bi-directional screen) technologies.

### SUMMARY

An exemplary aspect is therefore directed to a user interface.

More specifically, an exemplary aspect is directed toward a prosthetic (or set of prosthetics) for use with an input device.

Even further aspects of the embodiments are directed toward a prosthetic, or set of prosthetics, for use with an input device, such as a touchpad, touchscreen, or comparable input device.

Even further aspects of the embodiments are directed toward mapping different functionality of the input device to different prosthetics.

Additional aspects are directed toward utilizing prosthetics with different shapes to affect different modes of behavior and input with an input device, such as a touchscreen or touchpad.

Even further aspects are directed toward providing handicapped individuals with increased dexterity by providing a prosthetic that allows different modes of behavior when used with an associated input device.

Additional aspects are directed toward an active prosthetic that includes, for example, an LED, RF transponder, or comparable electrical, optical, and/or electromagnetic componentry that allows the characteristics of the prosthetic to be changed. These characteristics then can be correlated to different modes of operation when used with a corresponding input device.

Even further aspects of the embodiments relate to a prosthetic that includes Rule 508 Compliance (Section 508 of the Workforce Rehabilitation Act Amendments of 1998—US Code of Federal Regulations, 36 CFR Part 1194) such as a spring loaded contact, tactile feedback to the user, audible feedback to the user, or the like.

Even further aspects of the embodiments relate to use of the prosthetic with one or more musical instruments, games, vehicles, gambling, medical applications, repair operations, or the like.

Additional aspects are directed toward a 3-D input device that utilizes one or more of a static and dynamic prosthetic for one or more of inputting information and manipulating content on an associated electronic device.

Even further aspects of the embodiments relate to detecting a distance of a prosthetic from an input device, such as a touchscreen or touchpad.

Additional aspects relate to a multimode active dynamic prosthetic with voice and/or vibration feedback that is capable of being used in a 3-D touchscreen or touchpad environment.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic even if performance of the process or operation uses human input, whether material or immaterial, received before performance of the process or operation. Human input is deemed to be material if such input influences how the process or operation will be performed. Human input that consents to the performance of the process or operation is not deemed to be “material”.

The term “computer-readable medium” as used herein refers to any non-transitory, tangible storage and/or transmission medium that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, RAM, PROM, EPROM, FLASH-EPROM, solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the embodiments are considered to include a tangible storage medium or distribution medium and prior art-recognized equivalents and successor media, in which the software implementations of the present embodiments are stored.

The terms “determine,” “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the embodiments are described in terms of exemplary embodiments, it should be appreciated that individual aspects of the embodiments can be separately claimed.

The preceding is a simplified summary of the embodiments to provide an understanding of some aspects of the embodiments. This summary is neither an extensive nor exhaustive overview of the embodiments. It is intended neither to identify key or critical elements of the embodiments nor to delineate the scope of the embodiments but to present selected concepts of the embodiments in a simplified form as an introduction to the more detailed description presented below. As will be appreciated, other embodiments are possible utilizing, alone or in combination, one or more of the features set forth above or described in detail below.

### BRIEF DESCRIPTION OF THE DRAWINGS

The exemplary embodiments disclosed herein will be discussed with relation to the figures wherein:

FIG. 1 illustrates an exemplary prosthetic input device;

FIG. 2 illustrates a second exemplary prosthetic input device; and

FIG. 3 is a flowchart outlining an exemplary method of operation of an input device.

### DETAILED DESCRIPTION

The techniques will be illustrated below in conjunction with an exemplary input device system. Although well suited for use with, e.g., a system such as a computer/electronic device, server(s), communications device and/or database(s), the embodiments are not limited to use with any particular type of electronic device(s) or system or configuration of system elements. Those skilled in the art will recognize that the disclosed techniques may be used in any application in which it is desirable to provide enhanced input capabilities.

The exemplary systems and methods will also be described in relation to software (such as drivers), modules, and associated hardware. However, to avoid unnecessarily obscuring the present embodiments, the following description omits well-known structures, components and devices that may be shown in block diagram form, are well known, or are otherwise summarized.

For purposes of explanation, numerous details are set forth in order to provide a thorough understanding of the embodiments. It should be appreciated, however, that the techniques disclosed herein may be practiced in a variety of ways beyond the specific details set forth herein.

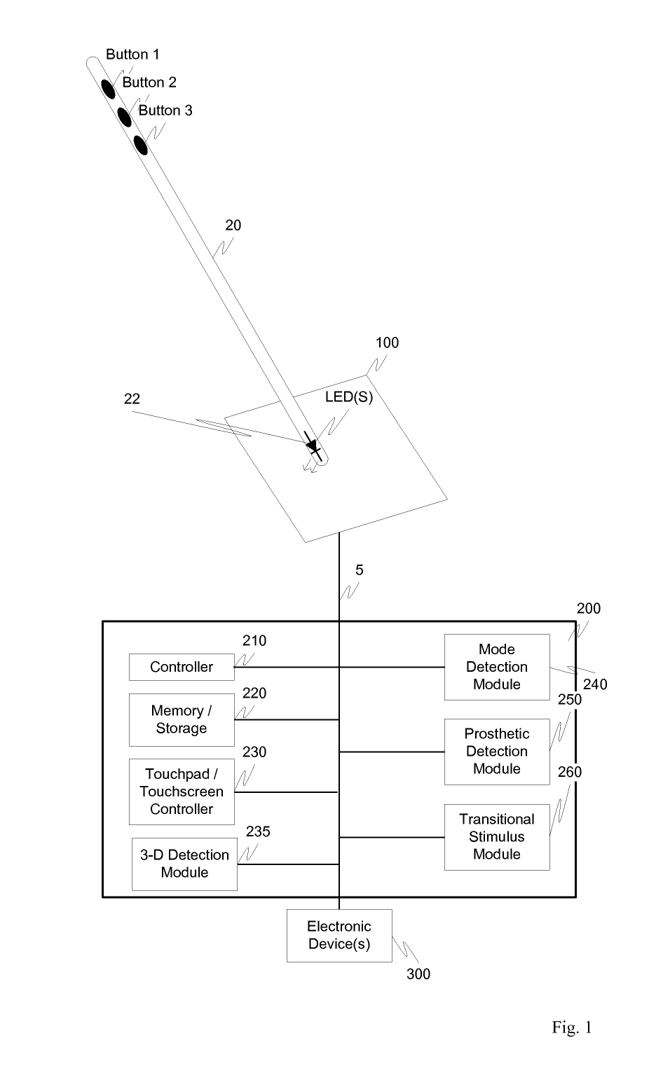

FIG. 1 illustrates an exemplary configuration of a prosthetic 20. More specifically, the prosthetic 20 cooperates with an input receiving device, such as touchpad, touchscreen, or track pad 100. The device 100 is connected, via link 5, to controller 210, memory 220, touchpad/touchscreen controller 230, an optional 3-D detection module 235, mode detection module 240, prosthetic detection module 250, and transition stimulus module 260, which are typically associated with an electronic device 300, such as a personal computer, laptop, netbook, personal digital assistant, GPS device, media player, or in general any electronic device that is capable of receiving input via one or more a touchscreen, track pad, touchpad, or the like.

While the input device/prosthetic 20 is illustrated in accordance with this exemplary embodiment in the traditional style of a stylus, it should be appreciated that the input device can be manipulated, based on the particular prosthetic needs of a user, and can be conformed into any shape as appropriate. For example, the input device may resemble a finger, an extension of an arm, a device that can be held in a user's mouth, or in general a symbol that any configuration as appropriate for the individual needs of the user.

In operation, and in accordance with first exemplary embodiment, the input device 20 is equipped with a plurality of buttons, here buttons 1, 2, and 3 that affect different modes of operation of the input device. For example, buttons 1-3 control the color of one or more LEDs 22 that are associated with the input device. The output of the LEDs 22 is detectable by the device 100 with a change in color of the LED corresponding to a change in input mode. More specifically, assume button 1 is pushed which corresponds to a red light being emitted from LED 22. In cooperation with the mode detection module 240 (and a corresponding optical sensor—not shown), the emitting of the red light is detected by device 100 and this correlated to the user's request (setup in a device driver file) to have red correspond to lower case letters. Next, when button 2 is pressed, LED 22 changes to a blue color, which, and in cooperation with the mode detection module 240 and touchpad/touchscreen controller 230, is mapped to a desire to have capital letters. Then, when button 3 is pressed, an LED 22 changes to a green color, again in cooperation with the mode detection module 240 and the touchpad/touchscreen controller 230, this equated to a request to activate a special character input mode.

While this exemplary embodiment is discussed in relation to LEDs and a change in color of light emitted from the LEDs, it should be fully appreciated that different electrical, magnetic, inductive, capacitive, ultrasonic, and in general any electrical/magnetic/optical technologies could be used with the embodiments disclosed herein. For example, LEDs 22 could be substituted with an RF module, an ultrasonic module, a resistive module, an inductive or magnetic module, or in general any electro/magnetic/inductive/optical technology. Moreover, while the above discussion is directed toward LEDs being red, green, and blue, other colors of LEDs are possible as well as other colors based on the illumination of two (or more) of the LEDs simultaneously. For example, simultaneous illumination of red and green LEDs produces yellow.

In addition to being able to determine what mode the input device 20 is in, and in cooperation with the transition stimulus module 260, mode detection module 240, and touchpad/touchscreen controller 230, patterns can also be detected. For example, if button 1 is pushed followed by button 3 followed by button 2 within a predetermined time period, that can correlated to a particular operational mode. In general, any pattern can be utilized by the transition stimulus module 260 change a mode of operation similar to the selection of a specific button.

In accordance with another exemplary embodiment, and in cooperation with the prosthetic detection module 250, it should be appreciated that various modes can be selected based on the type of prosthetic. For example, instead of having a three button prosthetic as illustrated in FIG. 1, there could be three separate prosthetics, one with a red LED, one with a blue LED, and one with a green LED. These three separate prosthetics, and in cooperation with a prosthetic detection module 250 and mode detection module 240 could be used in a similar manner to the techniques described above. This may be advantageous, for example, for an individual that is incapable of selecting the mode buttons as illustrated in FIG. 1, but could selected a different prosthetic based on a desired of different mode of operation.

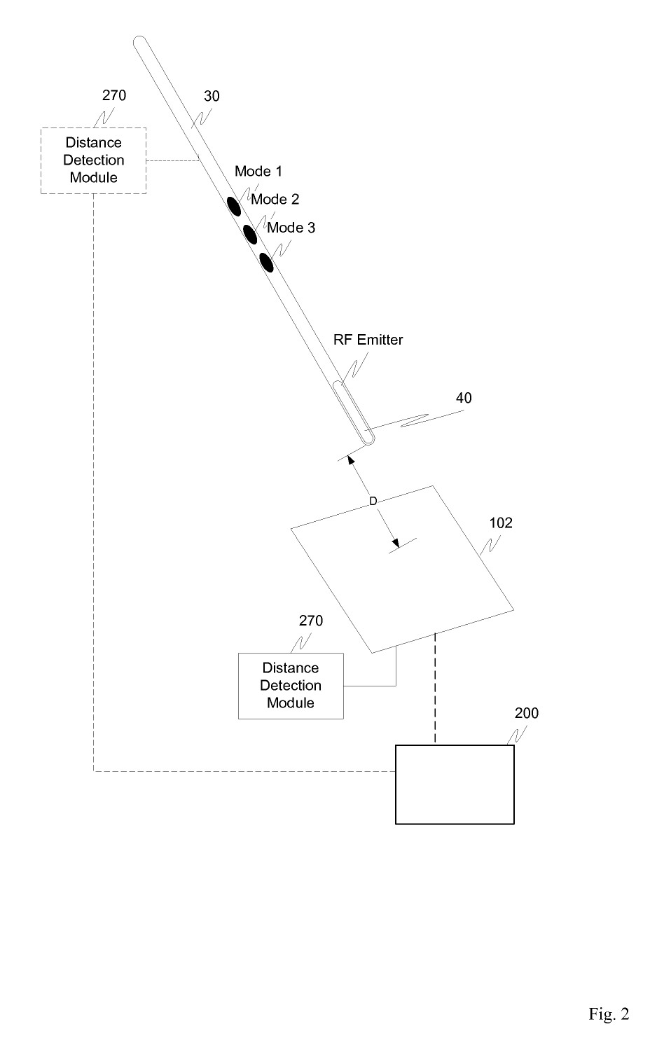

FIG. 2 illustrates another exemplary embodiment that can include one or more of the features discussed above in relation to FIG. 1, as well as optionally be associated with a distance detection module that allow the distance between the input device 30 and the touchscreen, touchpad, or track pad 102 to be determined. This allows, for example, a 3-D type of input device that can be very useful for certain applications.

More specifically, and in cooperation with the distance detection module, which could be one or more of associated with the prosthetic 30 or device 102, a distance between, for example, the tip of the prosthetic 30 and the device 102 can be determined (D). For example, this could be based on one or more of RF, with the cooperation of the RF emitter 40, optical technology, such as a laser, a lazing LED, absolute position detection means, or the like, magnetic and/or inductive technologies, or in general any technology that allows a distance to be determined between the prosthetic 30 and device 102. Additionally, and as illustrated in FIG. 2, the distance detection module can be associated with device 102 and/or the prosthetic 30. For example, the prosthetic 30 could be so equipped as to determine a distance from the device 102 that may allow, for example, greater backwards compatibility with existing touchpad, touchscreen, and track pad devices. As will be appreciated, the embodiment in FIG. 2 could also combined with, for example, the different modes of operation as discussed in relation to FIG. 1, and moreover could also be used with different prosthetics as discussed in relation to FIG. 1.

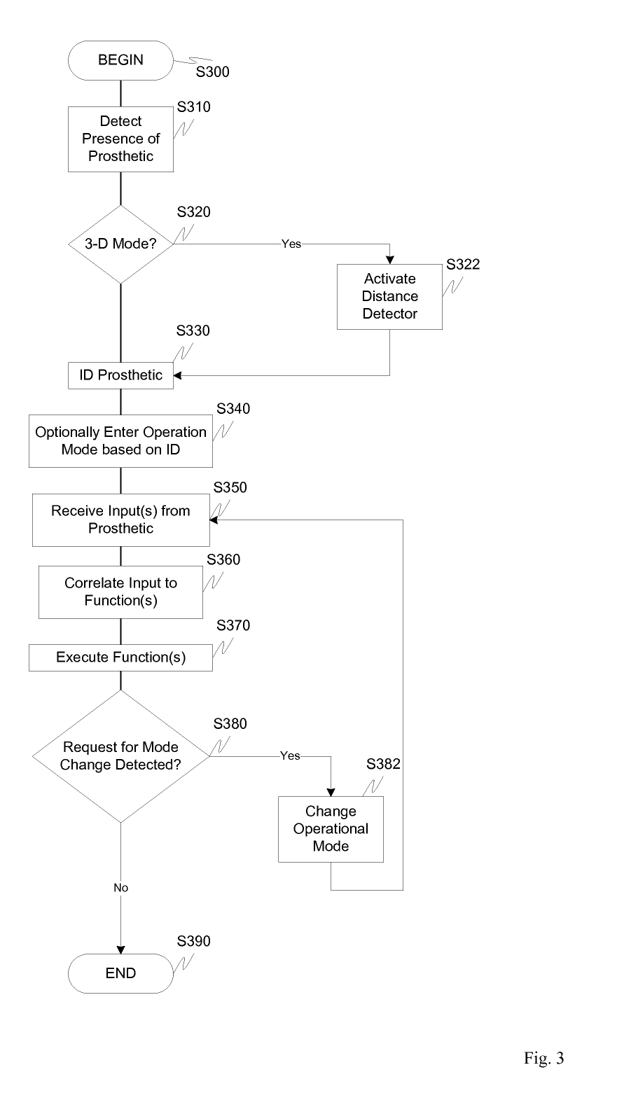

FIG. 3 outlines an exemplary mode of operation of an input device. In particular, control begins in step S300 and continues to step S310. In step S310, the presence of a prosthetic is detected. Next, in step S320, a determination is made whether a 3-D mode should be entered. If a 3-D should be entered, control continues to step S322 with control otherwise jumping to step S330.

In step S322, a distance detector is activated with a corresponding input of the distance from the prosthetic to a touchpad, touchscreen, or track pad used as input as discussed below.

In step S330, and in accordance with an optional embodiment, a prosthetic can be identified. For example, as an alternative to, or in addition to, the various modes of operation as discussed in relation to FIGS. 1 and 2, there could be separate prosthetics corresponding to each mode. Each of these prosthetics can have an associated ID, in a similar manner to the way the different colored LEDs are used as discussed above.

In accordance with yet another embodiment, different prosthetics which have different detectable shapes can be used in a similar manner. For example, a first shape could have a first electrical/resistive/capacitive signature that could operate in a manner similar to the red LED embodiment described above. A second shape could have a second electrical/resistive/capacitive signature that could operate in a manner similar to the blue LED embodiment described above, etc. As discussed above exemplary function(s) can be correlated to the prosthetic and/or mode of operation a prosthetic is in, optionally in cooperation with the placement of the prosthetic relative to a touchpad, touchscreen, or comparable input device.

If different prosthetics are used, and in step S340, an operational mode is entered based on the prosthetic ID. For example, a user may have a first, second, and third fingers each of which have different prosthetics. Associated with each of these prosthetics could be a specific mode of operation such that, for example, on the first finger lower case letters are entered, on the second finger upper case letters are entered, and for the third finger special characters are entered. Next in step S350, input is received from the prosthetic. As discussed, this can be traditional input such as when the prosthetic comes into contact with the touchscreen, touchpad, or track pad, and it can also include distance input if the device is operating in a 3-D mode. This 3-D mode could be used, for example, to manipulate 3-D dimensional objects on an electronic device, and/or could be used to trigger differing modes of operation based on, for example, the distance of the prosthetic from a sensing area such as a touchpad, track pad, or touchscreen. Control then continues to step S360.

In step S360, a correlation is made between the type(s) of inputs received from the prosthetic and a corresponding function on the electronic device. Next, in step S370 that function is executed with control continuing to step S380.

In step S380, a determination is made whether there has been a request for a change in mode. For example, and as previously discussed, may be a user has selected a red LED instead of the blue LED. Similarly, if a pattern has been detected, such as red-blue-green in step S382 that request for a change is recognized and the mode of the input device helped her to reflect that requested change. Control then jumps back to step S350.

If a request for a mode change is not detected, control continues to step S390 where the control sequence ends.

As can be appreciated by one skilled in the art, although specific methods and techniques have been described for using detected input of contact portions of a finger/prosthetic on a touch-screen, touch pad, or the like, other known pattern recognition methods can be employed to determine inputs.

While the above-described flowchart has been discussed in relation to a particular sequence of events, it should be appreciated that changes to this sequence can occur without materially effecting the operation of the embodiments. Additionally, the exact sequence of events need not occur as set forth in the exemplary embodiments. The exemplary techniques illustrated herein are not limited to the specifically illustrated embodiments but can also be utilized with the other exemplary embodiments and each described feature is individually and separately claimable.

The systems, methods and protocols can be implemented on a special purpose computer in addition to or in place of the described communication equipment, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a communications device, such as a phone, any comparable means, or the like. In general, any device capable of implementing a state machine that is in turn capable of implementing the methodology illustrated herein can be used to implement the various communication methods, protocols and techniques herein.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The security systems, methods and protocols illustrated herein can be readily implemented in hardware and/or software using any known or later developed systems or structures, devices and/or software by those of ordinary skill in the applicable art from the functional description provided herein and with a general basic knowledge of the computer and security arts.

Moreover, the disclosed methods may be readily implemented in software that can be stored on a storage medium, executed on a programmed general-purpose computer with the cooperation of a controller and memory, a special purpose computer, a microprocessor, or the like. In these instances, the systems and methods of this invention can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications device or system.

It is therefore apparent that there has been provided systems, apparatuses and methods for detecting input(s) to an electronic device. While these embodiments have been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

1. An input method for an electronic device comprising:
detecting one or more of a selected mode of operation and identification information associated with a prosthetic;
detecting an input from the prosthetic; and
correlating the input based on the selected mode of operation or the identification information associated with the prosthetic to one or more functions, wherein the functions are used as input to the electronic device.

2. The method of claim 1, wherein the prosthetic includes one or more selectable buttons that allow user selection of one or more modes of operation.

3. The method of claim 1, further comprising detecting a distance from an input receiving device.

4. The method of claim 3, wherein the input receiving device is a touchpad, touchscreen or track pad.

5. The method of claim 1, wherein the selected mode is detectable by an input receiving device, the input receiving device detecting one or more of a color of light emitted from the prosthetic and a change in electrical, magnetic, inductive, capacitive or ultrasonic characteristics of the prosthetic, further wherein the prosthetic includes one or more of an RF module, an ultrasonic module, a resistive module, an inductive or magnetic module and an LED module.

6. The method of claim 1, wherein multiple prosthetics, each having an associated identifier and corresponding functionality, are used with the electronic device.

7. The method of claim 1, wherein the prosthetic is a multimode active dynamic prosthetic that includes feedback that is capable of providing input to a 3-D touchscreen or touchpad.

8. The method of claim 1, further comprising detecting a pattern of selected modes of operation.

9. One or more means for performing the steps of claim 1.

10. A non-transitory computer-readable storage media, having instructions stored thereon, that when executed cause the steps of claim 1 to be performed.

11. An input device for an electronic device comprising:
one or more of:
a mode detection module that detects a selected mode of operation of a prosthetic, and
a prosthetic detection module that detects identification information associated with the prosthetic;
a controller that detects an input from the prosthetic and correlates the input based on the selected mode of operation or the identification information associated with the prosthetic to one or more functions, wherein the functions are used as input to the electronic device.

12. The device of claim 11, wherein the prosthetic includes one or more selectable buttons that allow user selection of one or more modes of operation.

13. The device of claim 11, further comprising a 3-D detection module that detects a distance from an input receiving device.

14. The device of claim 13, wherein the input receiving device is a touchpad, touchscreen or track pad.

15. The device of claim 11, wherein the selected mode is detectable by an input receiving device, the input receiving device detecting one or more of a color of light emitted from the prosthetic and a change in electrical, magnetic, inductive, capacitive or ultrasonic characteristics of the prosthetic, further wherein the prosthetic includes one or more of an RF module, an ultrasonic module, a resistive module, an inductive or magnetic module and an LED module.

16. The device of claim 11, wherein multiple prosthetics, each having an associated identifier and corresponding functionality, are used with the electronic device.

17. The device of claim 11, wherein the prosthetic is a multimode active dynamic prosthetic that includes feedback that is capable of providing input to a 3-D touchscreen or touchpad.

18. The device of claim 11, further comprising detecting a pattern of selected modes of operation.

19. The device of claim 11, wherein the input device is a touchscreen, a touchpad, a track pad or a device that detects a presence and a location of a touch within an area.

20. The device of claim 1, wherein the identification information associated with the prosthetic is based on one or more of a shape of the prosthetic and one or more of an electrical, resistive and capacitive signature.
